(19) United States
(12) Patent Application Publication
(10) Pub. No.: US 2012/0113251 A1
(43) Pub. Date: May 10, 2012

(54) METHOD AND APPARATUS FOR CALCULATING POSITION INFORMATION OF AN IMAGE

(75) Inventors: Ki-beom KIM, Seoul (KR); Jin-wang An, Yeongcheon-si (KR)

(73) Assignee: Samsung Electronics Co., Ltd., Gyeonggi-do (KR)

(21) Appl. No.: 13/292,417

(22) Filed: Nov. 9, 2011

(30) Foreign Application Priority Data
Nov. 10, 2010 (KR) 10-2010-0111568

(51) Int. Cl. G06K 9/00; H04N 7/18

(52) U.S. Cl. 348/135; 382/107; 348/E07.087

(57) ABSTRACT

The present invention provides a method and apparatus for calculating position information of an image captured by an imaging device, the method including capturing the image by an imaging device; determining whether position information is available; measuring a movement direction and a velocity of the imaging device, when the position information is not available; re-determining whether the position information is available; selectively acquiring a current reference point using the position information, when the position information is now available; and calculating the position information corresponding to the image based on the movement direction, the velocity, and the current reference point.

### PRIORITY

This application claims priority to Korean Patent Application No. 10-2010-0111568, filed on Nov. 10, 2010, in the Korean Intellectual Property Office, the contents of which are incorporated herein by reference.

### BACKGROUND OF THE INVENTION

1. Field of the Invention

The present invention relates generally to a method and apparatus for calculating position information of an image by using various sensor units, and more particularly, to a method and apparatus for correcting a position of an image captured by an imaging device, such as a camera, in which is installed a position information acquiring unit, such as a Global Positioning System (GPS).

2. Description of the Related Art

When a conventional imaging device does not receive position information, the conventional imaging device in which a GPS is installed forces a user to directly indicate his/her position by using pre-stored map data. When the conventional imaging device receives position information, it stores the position information without correction.

While a booting time of an imaging device generally takes about one second or less, the booting time of a GPS can be several minutes. Accordingly, an image is often captured before the GPS is initialized, and the imaging device may not provide accurate position information of such an image.

Also, even after the GPS is initialized, the imaging device may not provide accurate position information when the GPS enters an area where position information is not received.

### SUMMARY OF THE INVENTION

The present invention provides a method and apparatus for correcting a position of an image captured by an imaging device in which a position information acquiring unit is installed captures an image before the position information acquiring unit is initialized.

According to an aspect of the present invention, a method of calculating a position of an image captured by an imaging device includes capturing the image by an imaging device; determining whether position information is available; measuring a movement direction and a velocity of the imaging device, when the position information is not available; re-determining whether the position information is available; selectively acquiring a current reference point using the position information, when the position information is now available; and calculating the position information corresponding to the image based on the movement direction, the velocity, and the current reference point.

According to another aspect of the present invention, an apparatus for calculating a position in an imaging device includes an image input unit for capturing the image; a sensor unit for measuring a movement direction and a velocity of the apparatus; a position information acquiring unit for selectively acquiring a current reference point; and a position information calculating unit for calculating the position information corresponding to the image. The position information acquiring unit determines whether position information is available, after the image input unit captures the image, the sensor unit measures the movement direction and the velocity of the apparatus, when the position information is not available, the position information acquiring unit re-determines whether the position information is available and selectively acquires the current reference point using the position information, when the position information is now available, and position information calculating unit calculates the position information corresponding to the image based on the movement direction, the velocity, and the current reference point.

According to another aspect of the present invention, a method of calculating a position of an image captured by an imaging device includes capturing the image by an imaging device; determining whether position information is available; measuring a movement direction and velocity of the imaging device, when the position information is not available; and calculating the position information corresponding to the image based on the movement direction, the velocity, and a previous reference point.

According to another aspect of the present invention, an apparatus for calculating a position in an imaging device includes an image input unit for capturing the image; a sensor unit for measuring a movement direction and a velocity of the apparatus; a position information acquiring unit for acquiring position information; and a position information calculating unit for calculating the position information corresponding to the image. The position information acquiring unit determines whether the position information is available, after the image input unit captures the image, the sensor unit measures the movement direction and the velocity of the apparatus, when the position information is not available, and the position information calculating unit calculates the position information corresponding to the image based on the movement direction, the velocity, and a previous reference point.

### BRIEF DESCRIPTION OF THE DRAWINGS

The above and other aspects, features and advantages of the present invention will become more apparent by describing in detail embodiments thereof with reference to the attached drawings in which:

FIG. 1 illustrates a method of correcting a position according to an embodiment of the present invention;

FIG. 2 illustrates a method of correcting a position when a position information acquiring unit enters an area where position information may not be received, according to an embodiment of the present invention;

FIG. 3 illustrates a method of correcting a position when an overall power-off event of the apparatus occurs before the position information acquiring unit is initialized, according to an embodiment of the present invention;

FIG. 4 illustrates a method of correcting a position of each of continuously captured images before the position information acquiring unit is initialized, according to an embodiment of the present invention;

FIG. 5 illustrates a method of correcting a position of each of continuously captured images after the position information acquiring unit is initialized, according to an embodiment of the present invention; and

FIG. 6 illustrates an apparatus for correcting a position according to an embodiment of the present invention.

### DETAILED DESCRIPTION OF THE INVENTION

Hereinafter, the present invention will be described in detail by explaining various embodiments of the invention with reference to the attached drawings. Like reference numerals in the drawings denote like elements. In the following description of the present invention, a detailed description of known functions and configurations incorporated herein will be omitted for clarity and conciseness.

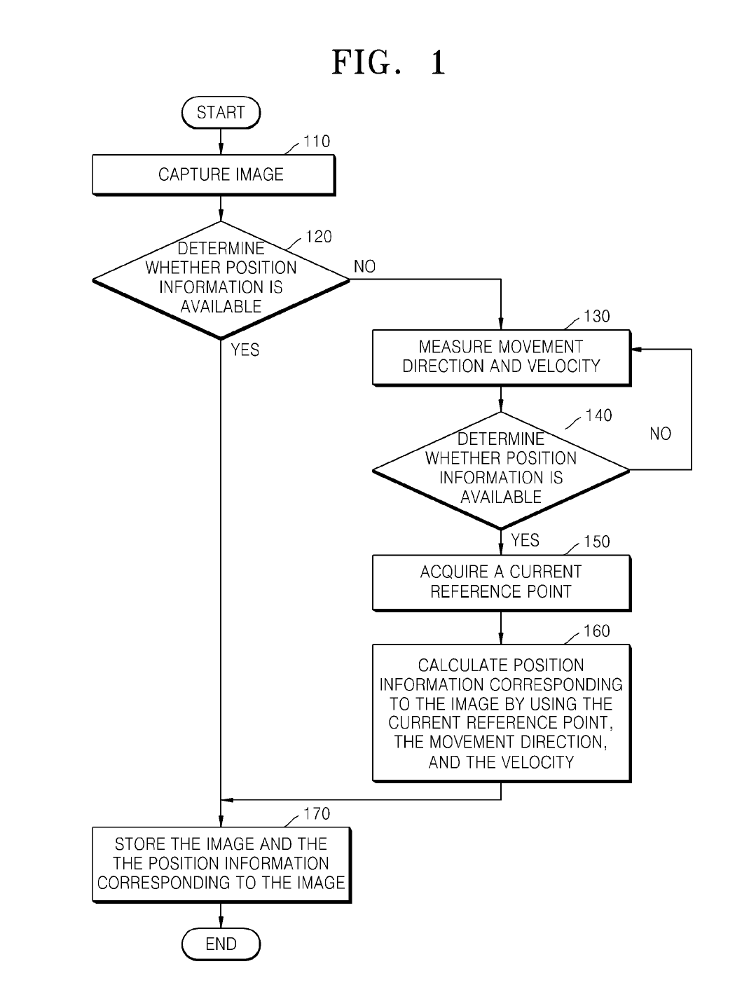

FIG. 1 illustrates a method of correcting a position according to an embodiment of the present invention.

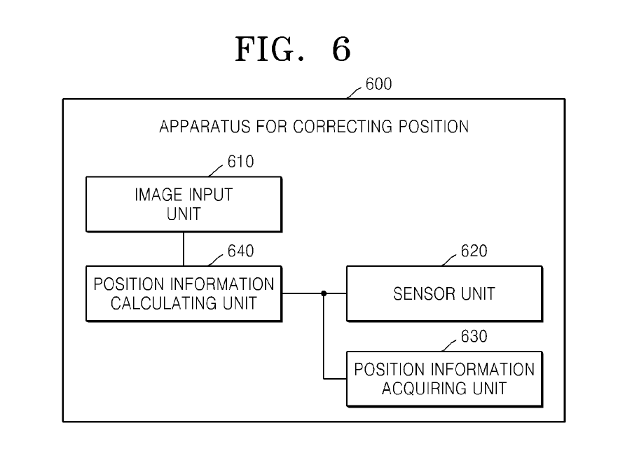

In step 110, an apparatus 600 for correcting a position captures an image by using an image input unit 610, as illustrated by the apparatus 600 in FIG. 6. The image input unit 610 includes a sensor that may input a digital image. Examples of the sensor include a charge-coupled device (CCD) and a Complementary-Metal-Oxide-Semiconductor (CMOS).

In step 120, the apparatus 600 determines whether position information is available by using a position information acquiring unit 630. If it is determined in step 120 that the position information is not available, the method proceeds to step 130, and if it is determined in step 120 that the position information is available, the method proceeds to step 170.

Although the position information acquiring unit 630 may be a GPS or a WiFi Positioning System (WPS) in FIG. 1, the method in FIG. 1 is not limited thereto, and the position information acquiring unit 630 may be based on other technologies.

In step 130, the apparatus 600 measures a movement direction and a velocity by using a sensor unit 620, which is one of a gyroscope, an accelerometer, and a geomagnetic sensor.

For example, the gyroscope measures a movement direction of the apparatus 600 per unit time, and the accelerometer measures acceleration. Accordingly, position information at a specific time is calculated as shown in Equation 1. (s:distance, v₀:velocity, t:time, a:acceleration)

s=v₀t+½at² (1)

In step 140, the apparatus 600 determines again whether position information is available. If it is determined in step 140 that the position information is not available, the method returns to step 130, where a movement direction and a velocity are re-measured, and in step 140, it is determined again whether position information is available. If it is determined in step 140 that the position information is not available, steps 130 and 140 are repeatedly performed. If it is determined in step 140 that the position information is available, the method proceeds to step 150, where the apparatus 600 acquires a current reference point that is position information at a current point of time.

In step 160, the apparatus 600 calculates position information corresponding to an image that is captured before the current reference point measured in step 150 based on the movement direction and the velocity.

In step 170, the apparatus 600 stores the image and the position information corresponding to the image.

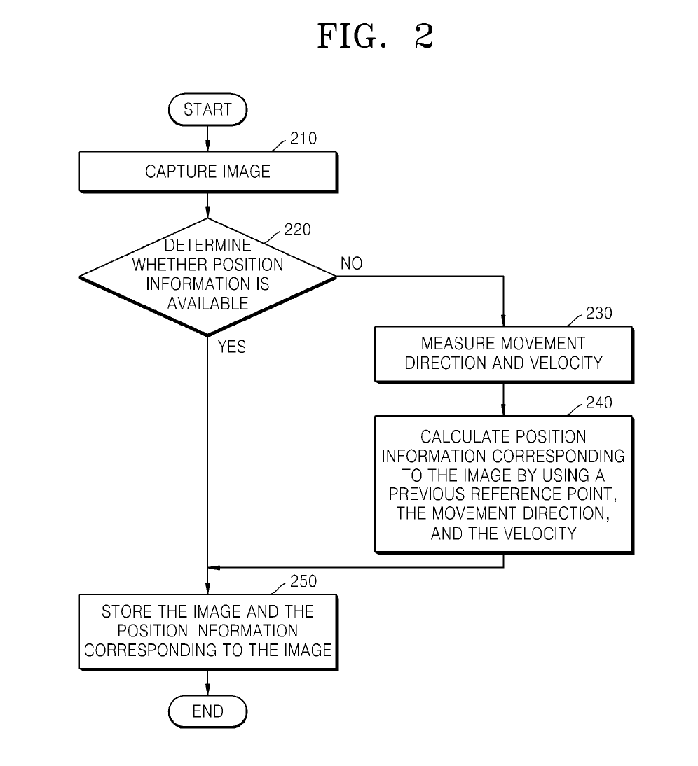

FIG. 2 illustrates a method of correcting a position when the position information acquiring unit 630 enters an area where position information is not received, according to the present invention.

When the position information acquiring unit 630 which is normally receiving position information enters an area where position information may not be received due to an obstruction such as a building or a tree, an image captured in the area may not have accurate position information. Accordingly, the method of FIG. 2 will now be explained.

In step 210, the apparatus 600 captures an image by using the image input unit 610 that includes a sensor that may input a digital image. Examples of the sensor include a CCD and a CMOS.

In step 220, the apparatus 600 determines whether position information is available by using the position information acquiring unit 630. If it is determined in step 220 that the position information is not available, the method proceeds to step 230, and if it is determined in step 220 that the position information is available, the method proceeds to step 250.

Although the position information acquiring unit 630 may be a GPS or a WPS in FIG. 2, the present invention is not limited thereto, and the position information acquiring unit 630 may be based on other technologies.

In step 230, the apparatus 600 measures a movement direction and a velocity by using the sensor unit 620, which is one of a gyroscope, an accelerometer, and a geomagnetic sensor.

Since the position information acquiring unit 630 acquires a previous reference point in FIG. 2, in step 240, the apparatus 600 calculates position information corresponding to an image captured after the previous reference point based on the movement direction and the velocity. Position information at a specific point of time is calculated as shown in Equation 1.

In step 250, the apparatus 600 stores the image and the position information corresponding to the image.

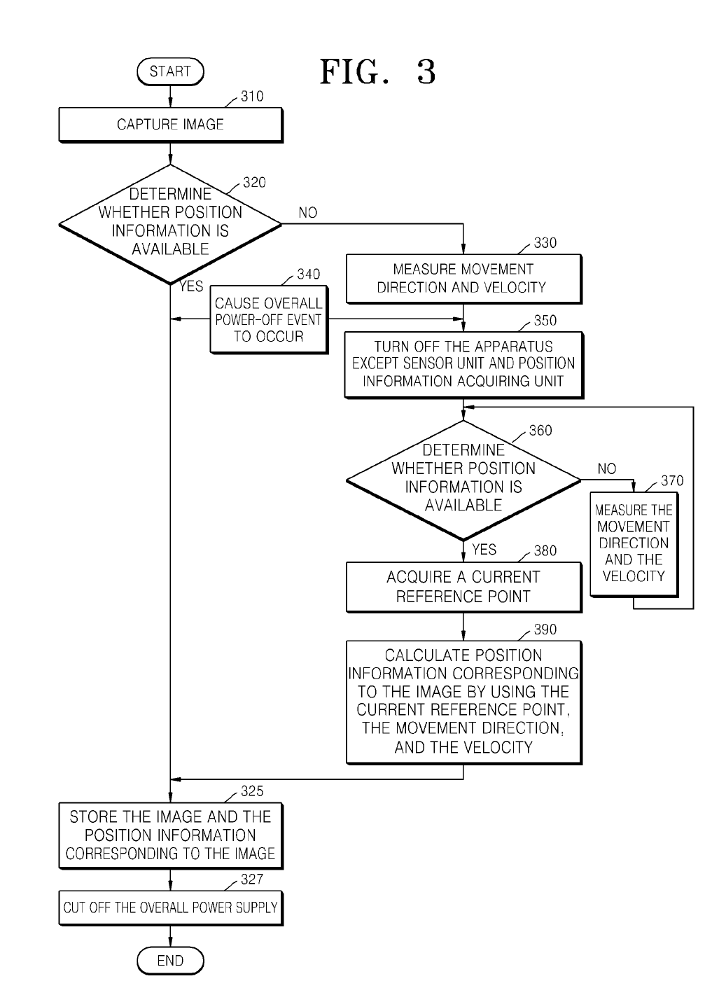

FIG. 3 illustrates a method of correcting a position when an overall power-off event of the apparatus 600 occurs before the position information acquiring unit 630 is initialized, according to the present invention.

If the apparatus 600 is turned off before the position information acquiring unit 630 is initialized, the apparatus 600 acquires neither a previous reference point nor a current reference point. Accordingly, the method of FIG. 3 will now be explained.

In step 310, the apparatus 600 captures an image by using the image input unit 610.

In step 320, the apparatus 600 determines whether position information is available by using the position information acquiring unit 630. If it is determined in step 320 that the position information is not available, the method proceeds to step 330, and if it is determined in step 320 that the position information is available, the method proceeds to step 325.

In step 330, the apparatus 600 measures a movement direction and a velocity by using the sensor unit 620. Accordingly, position information at a specific point of time is calculated as shown in Equation 1.

In step 340, an overall power-off event of the apparatus 600 occurs.

In step 350, the apparatus 600 is turned off except the sensor unit 620 and the position information acquiring unit 630.

In step 360, the apparatus 600 determines again whether position information is available by using the position information acquiring unit 630. If it is determined in step 360 that the position information is not available, the method proceeds to step 370. In step 370, a movement direction and a velocity are re-measured. It is determined again in step 360 whether position information is available. If it is determined in step 360 that the position information is not available, steps 370 and 360 are repeatedly performed. If it is determined in step 360 that the position information is available, the method proceeds to step 380, where the apparatus 600 acquires a current reference point that is position information at a current point of time.

In step 390, the apparatus 600 calculates position information corresponding to an image captured before the current reference point measured in step 380 based on the movement direction and the velocity. Position information at a specific point of time is calculated as shown in Equation 1.

In step 325, the apparatus 600 stores the image and the position information corresponding to the image, and in step 327, the apparatus 600 cuts off overall power supply.

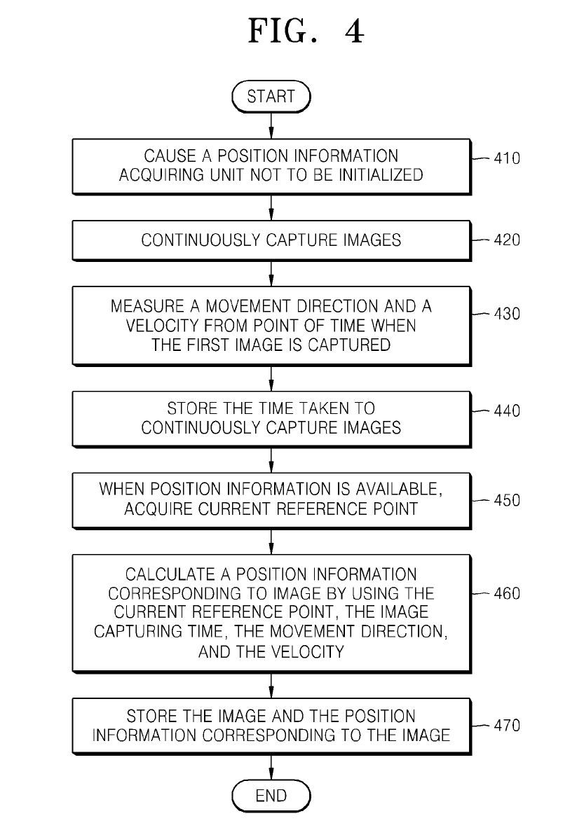

FIG. 4 illustrates a method of correcting a position of each of continuously captured images before the position information acquiring unit 630 is initialized, according to another embodiment of the present invention.

In step 410, the position information acquiring unit 630 of the apparatus 600 is not initialized.

In step 420, the apparatus 600 continuously captures images by using the image input unit 610.

Since the position information acquiring unit 630 is not initialized yet, in step 430, the apparatus 600 measures a movement direction and a velocity from a point of time when a first image is captured by using the sensor unit 620.

In step 440, the apparatus 600 stores a time taken to continuously capture the images.

In step 450, if the apparatus 600 may acquire position information, the apparatus 300 acquires a current reference point that is position information at a current point of time.

In step 460, the apparatus 600 calculates position information corresponding to each of images continuously captured after the current reference point is acquired in step 450, based on the movement direction and the velocity.

In step 470, the apparatus 600 stores the image and the position information corresponding to the image.

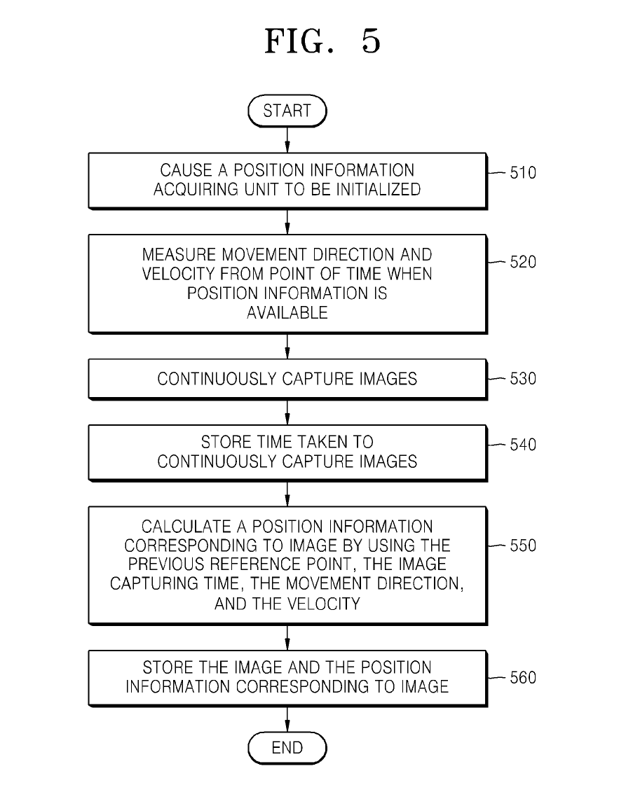

FIG. 5 illustrates a method of correcting a position of each of continuously captured images after the position information acquiring unit 630 is initialized, according to the present invention.

In step 510, the position information acquiring unit 630 of the apparatus 600 is already initialized.

In step 520, the apparatus 600 calculates a movement direction and a velocity by using the sensor unit 620 from a point of time when the position information acquiring unit 630 may not acquire position information.

In step 530, the apparatus 600 continuously captures images by using the image input unit 610.

In step 540, the apparatus 600 stores a time taken to continuously capture the images.

Since the position information acquiring unit 630 acquires a previous reference point in FIG. 5, in step 550, the apparatus 600 calculates position information corresponding to each of images continuously captured after the previous reference point based on the movement direction and the velocity. Position information at a specific point of time is calculated as shown in Equation 1.

In step 560, the apparatus 600 stores the image and the position information corresponding to the image.

FIG. 6 illustrates the apparatus 600 according to the present invention.

The apparatus 600 includes the image input unit 610, the sensor unit 620, the position information acquiring unit 630, and a position information calculating unit 640.

The image input unit 610 captures an image and includes a sensor that may input a digital image. Examples of the sensor include a Charge Coupled Device (CCD) and a Complementary Metal Oxide Semiconductor (CMOS). The image input unit 610 may continuously capture images, and position correction described below may be performed on each of the continuously captured images.

If position information corresponding to an image is not available, the sensor unit 620 measures a movement direction and a velocity. The sensor unit 620 is one of a gyroscope, an accelerometer, and a geomagnetic sensor.

If position information corresponding to an image is available, the position information acquiring unit 630 selectively acquires a current reference point that is position information at a current point of time. When a previous reference point does not exist, the position information acquiring unit 630 acquires the current reference point. Although the position information acquiring unit 630 may be a GPS or a WPS in FIG. 6, the present invention is not limited thereto, and the position information acquiring unit 630 may be based on other technologies.

The position information calculating unit 640 calculates position information corresponding to an image by using the movement direction and the velocity. If a previous reference point does not exist, the position information calculating unit 640 calculates the position information corresponding to the image captured before the current reference point based on the movement direction and the velocity. If the previous reference point exists, the position information calculating unit 640 calculates the position information corresponding to the image captured after the previous reference point based on the movement direction and the velocity.

The apparatus 600 may further include a storage unit (not shown) that stores the image and the position information corresponding to the image, which may include each of the continuously captured images.

Power may be partially supplied to the sensor unit 620 and the position information acquiring unit 630 when an overall power-off event occurs.

The apparatus 600 may further include a power supply unit that stores the image and the position information corresponding to the image and then cuts off overall power supply when an overall power-off event occurs.

According to the present invention, by overcoming the disadvantage of the long booting time, the apparatus 600 calculates accurate position information of an image captured before the position information acquiring unit 630 is initialized.

Even when the position information acquiring unit 630 is initialized and then enters an area where position information is not received, the apparatus 600 calculates and provides accurate position information corresponding to an image.

The apparatus 600 also calculates and provides accurate position information corresponding to an image when capturing an image and an overall power-off event of the apparatus 600 occurs before the position information acquiring unit 630 is initialized.

Additionally, the apparatus 600 according to the one or more embodiments of the present invention may include a bus coupled to the units shown in FIG. 6 and at least one processor coupled to the bus, and may further include a memory that is coupled to the bus in order to store a command, a received message, and a generated message and is coupled to the at least one processor in order to perform the above-described commands.

The present invention may be embodied as computer-readable codes on a computer-readable recording medium. The computer-readable recording medium is any data storage device that can store data which can be thereafter read by a computer system. Examples of the computer-readable recording medium include storage media such as magnetic storage media (e.g., Read Only Memories (ROMs), floppy discs, or hard discs), optically readable media (e.g., Compact Disc-Read Only Memories (CD-ROMs), or Digital Video Discs (DVDs)). The computer-readable recording medium can be distributed in a computer system connected to a network, and stored and executed as a computer-readable code in a distributed computing environment.

While the present invention has been particularly shown and described with reference to certain embodiments thereof, it will be understood by those of ordinary skill in the art that various changes in form and details may be made therein without departing from the spirit and scope of the present invention as defined by the following claims.

What is claimed is:

1. A method of calculating position information corresponding to an image, the method comprising:
capturing the image by an imaging device;
determining whether position information is available;
measuring a movement direction and a velocity of the imaging device, when the position information is not available;
re-determining whether the position information is available;
selectively acquiring a current reference point using the position information, when the position information is now available; and
calculating the position information corresponding to the image based on the movement direction, the velocity, and the current reference point.

2. The method of claim 1, further comprising storing the image and the position information corresponding to the image.

3. The method of claim 2, wherein measuring the movement direction and the velocity and the selectively acquiring the current reference point is performed when the imaging device is partially powered-down.

4. The method of claim 3, further comprising:
storing the image and the position information corresponding to the image; and
fully powering-down the imaging device.

5. A method of calculating position information corresponding to an image, the method comprising:
capturing the image by an imaging device;
determining whether position information is available;
measuring a movement direction and velocity of the imaging device, when the position information is not available; and
calculating the position information corresponding to the image based on the movement direction, the velocity, and a previous reference point.

6. The method of claim 5, further comprising storing the image and the position information corresponding to the image.

7. An apparatus for calculating position information of an image, the apparatus comprising:
an image input unit for capturing the image;
a sensor unit for measuring a movement direction and a velocity of the apparatus;
a position information acquiring unit for selectively acquiring a current reference point; and
a position information calculating unit for calculating the position information corresponding to the image,
wherein the position information acquiring unit determines whether position information is available, after the image input unit captures the image, the sensor unit measures the movement direction and the velocity of the apparatus, when the position information is not available, the position information acquiring unit re-determines whether the position information is available and selectively acquires the current reference point using the position information, when the position information is now available, and position information calculating unit calculates the position information corresponding to the image based on the movement direction, the velocity, and the current reference point.

8. The apparatus of claim 7, further comprising a storage unit for storing the image and the position information corresponding to the image.

9. The apparatus of claim 8, wherein power is partially supplied to the sensor unit and the position information acquiring unit when an overall power-off event occurs in the apparatus.

10. The apparatus of claim 9, further comprising a power supply unit for storing the image and the position information corresponding to the image and then cutting off the power that is partially supplied to the sensor unit and the position information.

11. The apparatus of claim 7, wherein the image comprises one or more continuously captured images.

12. The apparatus of claim 7, wherein the sensor unit comprises one of:
a gyroscope;
an accelerometer; and
a geomagnetic sensor.

13. The apparatus of claim 7, wherein the image input unit comprises a sensor that inputs a digital image, the sensor including one of a Charge Coupled Device (CCD) and a Complementary Metal Oxide Semiconductor (CMOS).

14. The apparatus of claim 7, wherein the position information acquiring unit comprises one of:
a Global Positioning System (GPS); and
a WiFi Positioning System (WPS).

15. An apparatus for calculating position information of an image, the apparatus comprising:
an image input unit for capturing the image;
a sensor unit for measuring a movement direction and a velocity of the apparatus;
a position information acquiring unit for acquiring position information; and
a position information calculating unit for calculating the position information corresponding to the image,
wherein the position information acquiring unit determines whether the position information is available, after the image input unit captures the image, the sensor unit measures the movement direction and the velocity of the apparatus, when the position information is not available, and the position information calculating unit calculates the position information corresponding to the image based on the movement direction, the velocity, and a previous reference point.

16. The apparatus of claim 15, further comprising a storage unit for storing the image and the position information corresponding to the image.

17. The apparatus of claim 15, wherein the sensor unit comprises one of:
a gyroscope;
an accelerometer; and
a geomagnetic sensor.

18. The apparatus of claim 15, wherein the image input unit comprises a sensor that inputs a digital image, the sensor including one of a Charge Coupled Device (CCD) and a Complementary Metal Oxide Semiconductor (CMOS).

19. The apparatus of claim 15, wherein the position information acquiring unit comprises one of:
a Global Positioning System (GPS); and
a WiFi Positioning System (WPS).

20. A computer-readable recording medium having recorded thereon a program for executing the method of correcting position information of an image, the method comprising:
capturing the image by an imaging device;
determining whether position information is available;
measuring a movement direction and a velocity of the imaging device, when the position information is not available;
re-determining whether the position information is available;
selectively acquiring a current reference point using the position information, when the position information is now available; and
calculating the position information corresponding to the image based on the movement direction, the velocity, and the current reference point.
